(19) United States
(12) Patent Application Publication
(10) Pub. No.: US 2007/0217134 A1
(43) Pub. Date: Sep. 20, 2007

(54) DISPLAY APPARATUS

(75) Inventor: Jong-hwa SHIN, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/533,556

(22) Filed: Sep. 20, 2006

(30) Foreign Application Priority Data
Sep. 21, 2005 (KR) 2005-87665

(51) Int. Cl. G06F 1/16

(52) U.S. Cl. 361/681; 248/917

(57) ABSTRACT

A display apparatus including a display main body that displays an image thereon and a base member, the display apparatus further including a lifting unit which includes a guide frame to stand on the base member and a lifting member coupled with the guide frame to move with the display main body; a pivoting unit which is provided between the display main body and the lifting member and supports the display main body to pivot around a pivot axis in clockwise and counterclockwise directions; and a locking unit which includes a moving member to be lifted together with the display main body and to move with a pivoting operation of the display main body, and a locking projection provided on the guide frame to limit the moving member from moving downward when the display main body remains pivoted.

### CROSS-REFERENCE TO RELATED APPLICATIONS

This application claims the benefit of Korean Patent Application No. 2005-0087665, filed on Sep. 21, 2005, in the Korean Intellectual Property Office, the disclosure of which is incorporated herein in its entirety by reference.

### BACKGROUND OF THE INVENTION

1. Field of the Invention

The present general inventive concept relates to a display apparatus, and more particularly, to a display apparatus having improved rotating and lifting configurations of a display main body.

2. Description of the Related Art

Generally, a display apparatus comprises a display main body which displays an image thereon, and a base member which is stably seated on an installing surface, such as a table, desk, wall, etc., to support the display main body.

Recently, the display main bodies have been employing a thin display panel, such as a liquid crystal display (LCD) panel or a plasma display panel (PDP).

Korean Patent Application No. 10-2002-0068264 discloses a monitor device as an example of a display apparatus which comprises a thin display panel. The conventional monitor device comprises a monitor main body, a base which supports the monitor main body, a guide rail which stands on a base member, a slider which is coupled with the monitor main body and is coupled with the guide rail to slide, and a spring which is connected with the slider and the guide rail. Thus, the monitor main body moves upwards and downwards along the guide rail.

The conventional monitor device may comprise a pivoting function through which the monitor main body pivots in forward and backward directions of the monitor device, to satisfy the needs of customers.

However, the conventional monitor device does not limit or prevent the monitor main body from moving downward toward the base while remaining in a pivoted position.

### SUMMARY OF THE INVENTION

The present general inventive concept provides a display apparatus which limits a display main body from moving downwards when in a pivoted position.

The present general inventive concept also provides a display apparatus which rotates a display main body in various directions with respect to a base member.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing a display apparatus comprising a display main body that displays an image thereon and a base member, the display apparatus further comprising a lifting unit which comprises a guide frame to connectably stand on the base member and a lifting member coupled with the guide frame to move with the display main body; a pivoting unit which is provided between the display main body and the lifting member and supports the display main body to pivot around a pivot axis in clockwise and counterclockwise directions; and a locking unit which comprises a moving member to be lifted together with the display main body and to move with a pivoting operation of the display main body, and a locking projection provided on the guide frame to limit the moving range of the moving member when the display main body remains pivoted.

The display apparatus may further comprise a moving member guide which is provided on the lifting member and to support the moving member to move in a backward direction of the display main body when the display main body pivots.

The locking unit may further comprise a pressure projection which rotates together with the display main body and presses the moving member backward when the display main body rotates.

The pressure projection comprises a protruding part which is shaped like a circular arc and presses the moving member when the display main body pivots, and an inclination part which is provided on an incline on an end part of the protruding part to gradually move the moving member.

A roller may be provided on an end part of the moving member to roll in contact with the pressure projection.

The locking unit may comprise an elastic member which biases the moving member toward the display main body.

The pivoting unit may comprise a pivoting bracket which is coupled with the display main body, and a pivoting shaft which supports the pivoting bracket to pivot with respect to the lifting member; and wherein the pressure projection is provided on the pivoting bracket.

The pivoting unit may comprise a pivoting bracket which is coupled with the display main body and a pivoting shaft which supports the pivoting bracket to pivot with respect to the lifting member; and wherein the pressure projection is provided on the pivoting bracket.

The lifting unit may further comprise a lifting spring which is provided between the lifting member and the guide frame to bias the lifting member upward.

The display apparatus may further comprise a swivel unit which is provided between the lifting unit and the base member and supports the display main body to swivel around a rotating axis in a lifting direction of the display main body.

The swivel unit may comprise a swivel bracket which is provided on a lower part of the guide frame; a swivel supporter which protrudes from the base member; and a swivel shaft which connects the swivel bracket and the swivel supporter to swivel.

The display apparatus may further comprise a tilting unit which is provided between the lifting unit and the pivoting unit and supports the display main body to tilt around a tilting shaft to face in upward and downward directions.

The tilting unit may comprise a tilting bracket which is coupled with the pivoting unit; a tilting supporter which is coupled with the lifting member; and a tilting shaft which tiltably connects the tilting bracket and the tilting supporter.

The foregoing and/or other aspects and utilities of the present general inventive concept are also achieved by providing a supporting apparatus comprising a base member to support a display main body displaying an image thereon, the supporting apparatus further comprising: a lifting unit which comprises a guide frame to connectably stand on the base member and a lifting member coupled with the guide frame to move with the display main body; a pivoting unit which is provided between the display main body and the lifting member and supports the display main body to pivot around a pivot axis in clockwise and counterclockwise directions; and a locking unit which comprises a moving member to be lifted together with the display main body and to move with a pivoting operation of the display main body, and a locking projection provided on the guide frame to limit the moving member from moving downward when the display main body remains pivoted.

The supporting apparatus may further comprise a moving member guide which is provided on the lifting member and supports the moving member to move in a backward direction of the display main body when the display main body pivots.

The supporting apparatus may further comprise a swivel unit which is provided between the lifting unit and the base member and supports the display main body to swivel around a rotating axis in a lifting direction of the display main body.

The supporting apparatus may further comprise a tilting unit which is provided between the lifting unit and the pivoting unit and supports the display main body to tilt around a tilting shaft to face in upward and downward directions.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a display apparatus according to the present general inventive concept;

FIG. 2 is an exploded perspective view of the display apparatus according to the present general inventive concept;

FIG. 3 is an exploded perspective view of a tilting unit, a pivoting unit and a locking unit of the display apparatus according to the present general inventive concept;

FIG. 4 is a perspective view of the tilting unit, the pivoting unit and the locking unit of the display apparatus according to the present general inventive concept when these units are coupled with each other;

FIGS. 5 and 6 are operational perspective views of the pivoting unit and the locking unit of the display apparatus according to the present general inventive concept;

FIG. 7 is a coupling perspective view of a lifting unit of the display apparatus according to the present general inventive concept; and

FIGS. 8 and 9 are operational perspective views of the lifting unit and the pivoting unit of the display apparatus according to the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

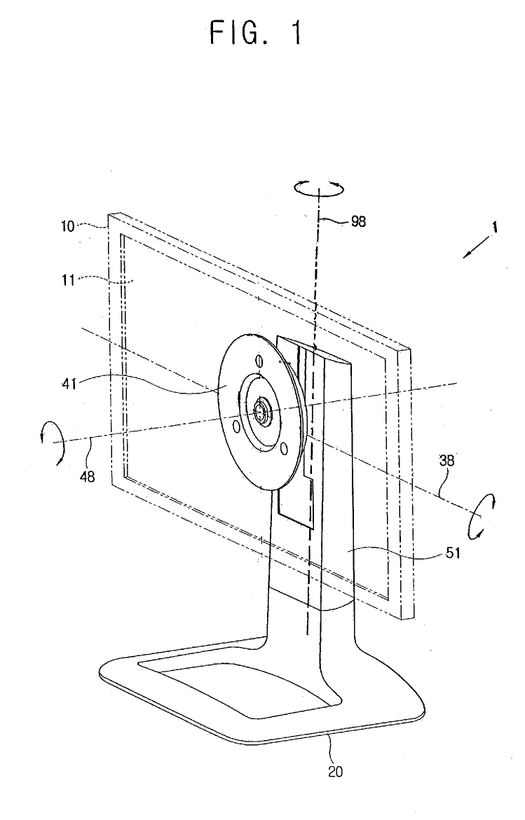

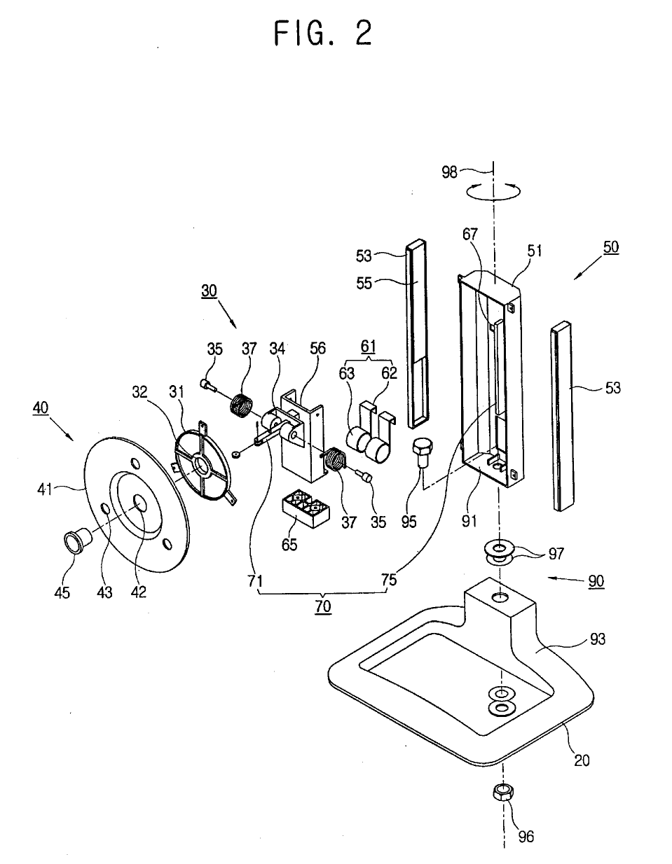

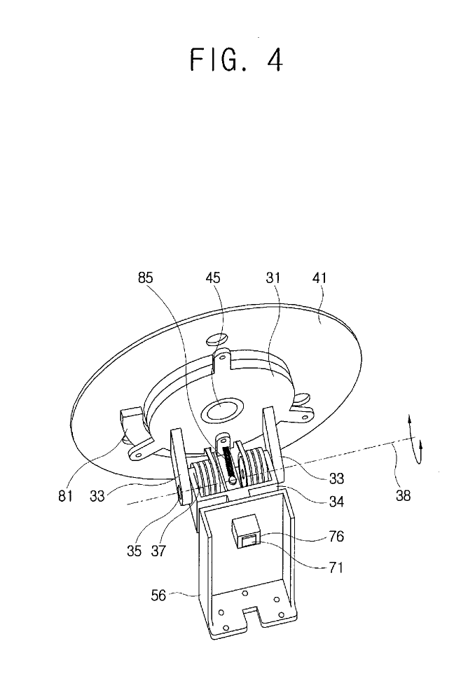

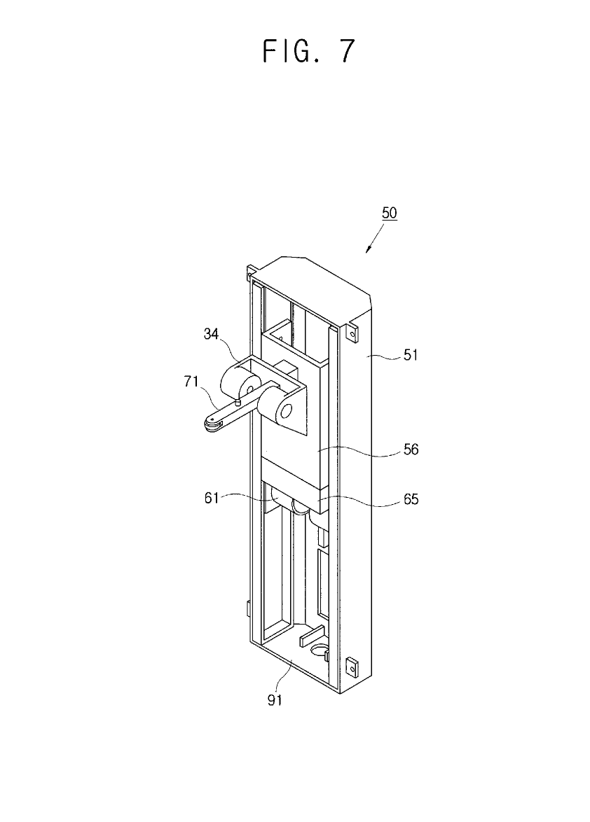

As illustrated in FIGS. 1 through 7, a display apparatus 1 according to the present general inventive concept comprises a display main body 10 (see, for example, FIGS. 1, 8 and 9) which displays an image thereon, a base member 20 which supports the display main body 10 with respect to an installing surface, a lifting unit 50 (see for example, FIG. 2) which is provided between the display main body 10 and the base member 20 to move the display main body 10 upward and downward with respect to the base member 20, a pivoting unit 40 which is provided between the display main body 10 and the lifting unit 50 and supports the display main body 10 to pivot around a pivot axis 48 in clockwise and counterclockwise directions (see FIG. 1), and a locking unit 70 which limits the display main body 10 from moving downward by the lifting unit 50 when the display main body 10 remains pivoted by the pivoting unit 40.

The display apparatus 1 according to the present general inventive concept may further comprise a swivel unit 90 which is provided between the lifting unit 50 and the base member 20 and supports the display main body 10 to swivel around a rotating axis 98 extending away from the base member 20 and in a lifting direction of the display main body 10, and a tilting unit 30 which is provided between the pivoting unit 40 and the lifting unit 50 and supports the display main body 10 to tilt around a tilt axis 38 to face in backward and forward directions (see FIG. 1).

The display main body 10 comprises a display panel 11 (see, for example, FIG. 1) having a thin plate shape, such as a liquid crystal display (LCD) or a plasma display panel (PDP), to display an image thereon; and a driving circuit (not illustrated) which drives the display panel 11. A plurality of coupling holes (not illustrated) may be provided on a rear surface of the display main body 10 to be coupled with a pivoting bracket 41 (to be described later) by one or more screws (not illustrated). The coupling holes of the display main body 10 may be formed thereon according to video electronic standard association (VESA) standards.

The base member 20 may be shaped like a plate to be installed on an installing surface such as a table. The base member 20 is coupled with a guide frame 51 of the lifting unit 50 (to be described later) and supports the guide frame 51 to stand upright with respect to the base member 20 and along the rotation axis 98.

As illustrated in FIGS. 1 through 4, the tilting unit 30 allows the display main body 10 tilt around the tilt axis 38 to face in the upward and downward directions with respect to the lifting unit 50. The tilting unit 30 can comprise a tilting bracket 31 which couples with the pivoting unit 40, a tilting supporting part 34 which couples with a lifting member 56 of the lifting unit 50 (to be described later), and a tilting shaft 35 which connects the tilting bracket 31 and the tilting supporting part 34 to allow the tilting bracket 31 to tilt upward and downward. The tilting unit 30 may further comprise one or more tilting springs 37 which is coupled with the tilting bracket 31 and the tilting supporting part 34.

The tilting bracket 31 can be in the form of a plate, and comprises a pivoting shaft coupler 32 which is provided at a center portion thereof to be coupled with a pivoting shaft 45 of the pivoting unit 40 (to be described later), and a tilting shaft coupler 33 which protrudes from a surface thereof toward the tilting supporting part 34 to be coupled therewith by the tilting shaft 35.

The tilting supporting part 34 is coupled with the lifting member 56 of the lifting unit 50 (to be described later) to move together with the lifting member 56. The tilting supporting part 34 is coupled with the tilting shaft coupler 33 of the tilting bracket 31 by the tilting shaft 35 so that the tilting bracket 31 tilts with respect to the tilting support part 34 with a predetermined friction force.

As an exemplary embodiment of the present general inventive concept, the tilting spring 37 can comprise a torsion coil spring, wherein a first side of the tilting spring 37 is coupled with the tilting bracket 31 and a second side thereof is coupled with the tilting supporting part 34 to press the tilting bracket 31 in an upward direction. The elastic force of the tilting spring 37 prevents the tilting bracket 31 from tilting downward due to the weight of the display main body 10.

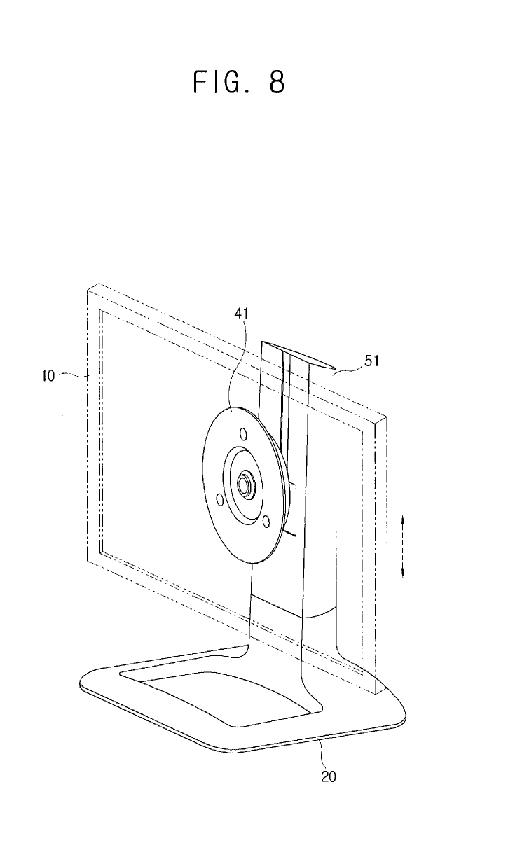

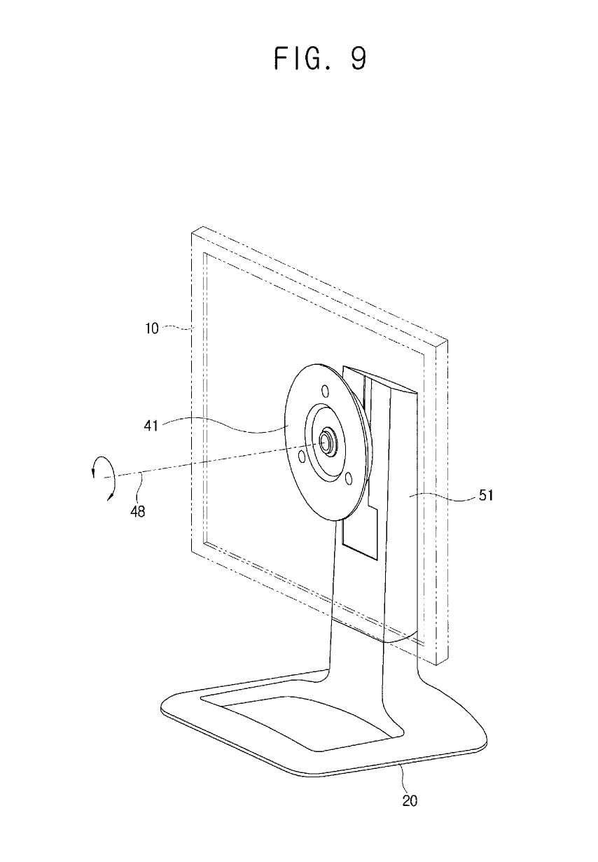

As illustrated in FIGS. 2 through 6, the pivoting unit 40 is provided between the display main body 10 and the tilting unit 30 to enable the display main body 10 to pivot around the rotating axis 48 in clockwise and counterclockwise directions within predetermined angles with respect to the lifting unit 50. The pivoting unit 40 comprises the pivoting bracket 41 which couples with the display main body 10, and the pivoting shaft 45 which supports the pivoting bracket 41 to pivot with respect to the lifting member 56 (and lifting unit 50). The predetermined angle ranges of the pivoting unit 40 may be variously set as 90° or 180°. As an exemplary embodiment of the present general inventive concept, a pre-pivoting state refers to a state wherein a longer length of the display main body 10 is disposed in leftward and rightward directions (see, for example, FIGS. 1 and 8), and a pivoting state refers to a state wherein a longer length of the display main body 10 is disposed in upward and downward directions (see FIG. 9).

A first side of the pivoting shaft 45 is accommodated and coupled to the pivoting shaft coupler 32 of the tilting bracket 31 and a second side of the pivoting shaft 45 is coupled with a pivoting shaft accommodator 42 of the pivoting bracket 41, thereby allowing pivoting of the pivoting bracket 41 with respect to the tilting bracket 31. An end part of the pivoting shaft 45 can be bent to have a predetermined rotation friction force while the pivoting shaft 45 is accommodated in the pivoting shaft coupler 32 of the tilting bracket 31 and the pivoting shaft accommodator 42 of the pivoting bracket 41.

The pivoting bracket 41 can have a shape like a plate. The pivoting shaft accommodator 42 is formed at a center portion of the pivoting bracket 41. The pivoting bracket 41 comprises a plurality of coupling holes 43 which are coupled with a rear part of the display main body 10 by screws (not illustrated).

The lifting unit 50 comprises the guide frame 51 which stands on the base member 20, and the lifting member 56 which is coupled with the guide frame 51 to move together with the display main body 10. The lifting unit 50 may further comprise a pair of guide rails 53 which are coupled at opposite sides of the guide frame 51 in a lengthwise direction, and a slider 55 coupled with each guide rail 53 to slide there along, and each slider is coupled to the lifting member 56 by a screw to move with the lifting member 56. The lifting unit 50 further comprises a lifting spring 61 which is coupled with the lifting member 56 and the guide frame 51 to provide a lifting force to the lifting member 56 in an upward direction.

The guide frame 51 has a rectangular box like shape to support the pair of guide rails 53 at opposite sides thereof. On a lower part of the guide frame 51 is provided a swivel bracket 91 of the swivel unit 90 (to be described later).

As an exemplary embodiment of the present general inventive concept, the lifting spring 61 can comprise a spiral spring which is wound like a roll, but is not limited thereto. Alternatively, the lifting spring 61 may be provided in various shapes, including a coil spring shape. A first side 62 of the lifting spring 61 can be bent to be coupled with a spring coupler 67 which is provided on an upper part of the guide frame 51, and a second side 63 thereof can be wound like a roll to contact a spring supporter 65 which is provided on a lower part of the lifting member 56. Thus, the lifting spring 61 provides a lifting force to the lifting member 56 in an upward direction with a predetermined elastic force. Such elastic force of the lifting spring 61 is similar to and in an opposing direction to the weight of the combination of the tilting unit 30, the pivoting unit 40 and the display main body 10 which are all coupled with the lifting member 56. The lifting spring 61 is not limited to the spiral spring type form. Alternatively, the lifting spring 61 may be provided in various forms, including a coil spring or a plate spring.

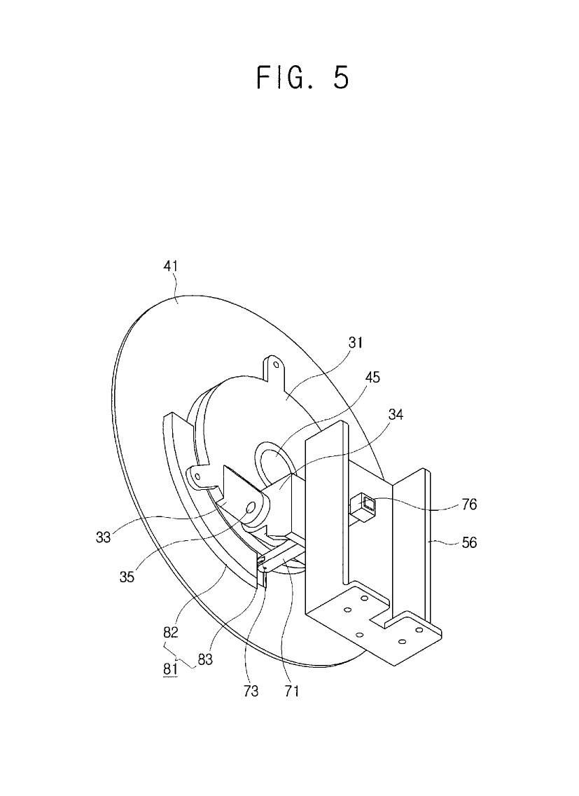

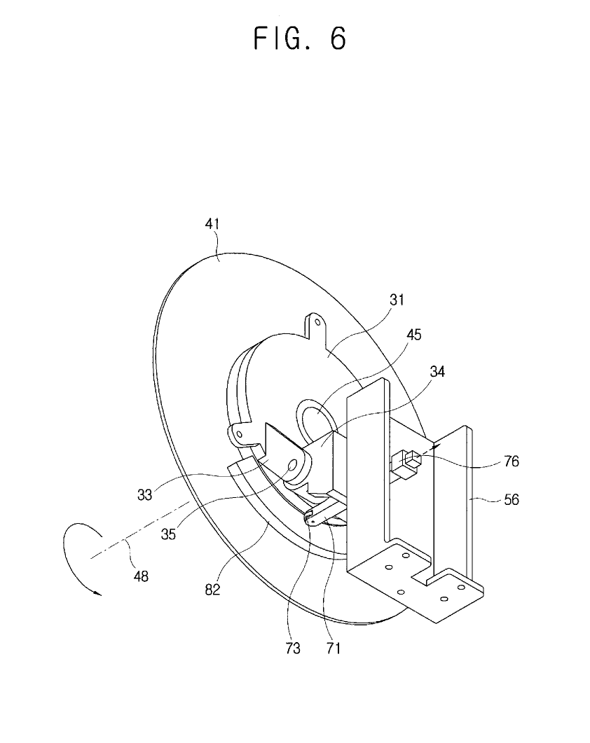

As illustrated in FIGS. 2 through 7, the locking unit 70 comprises a moving member 71 which integrally moves with the display main body 10 and moves with a pivoting operation of the display main body 10, and a locking projection 75 which is provided on the guide frame 51 and limits the moving member 71 from moving downward along the guide frame 51 when the display main body 10 is in the pivoted position. The locking unit 70 further comprises a pressure projection 81 (see, for example, FIGS. 5 and 6) which rotates together with the display main body 10 and presses the moving member 71 backward away from the display main body 10 and toward the guide frame 51 when the display main body 10 pivots or rotates. The locking unit 70 may further comprise an elastic member 85 which pulls the moving member 71 toward the display main body 10 by connecting one end of the elastic member 85 to the tilting bracket 31 and another end of the elastic member 85 to the moving member 71.

The moving member 71 can be shaped like an elongated bar to move with the pivoting operation of the display main body 10 and to move in forward and backward directions (between the display main body 10 and the guide frame 51) in response to the movement of the display main body 10 in a pivoting direction (along axis 48) and/or a tilting direction (along axis 38). The moving member 71 is accommodated in and guided by a moving member guide 76 which is provided on the lifting member 56 and is lifted with the lifting member 56. A roller 73 is provided on one end of the moving member 71 to cause a roll-contact with the pressure projection 81.

The moving member guide 76 is formed on the lifting member 56 in is disposed in a direction to support the moving member 71 to move in a backward direction toward the guide frame 51 and in a forward direction toward the display main body 10 when the display main body 10 pivots. As an exemplary embodiment of the present general inventive concept, the moving member guide 76 has a rectangular shape corresponding to a shape of the moving member 71, but is not limited thereto. The moving member guide 76 may be provided in various shapes including a circular or an oval shape to accommodate the shape of the moving member 71.

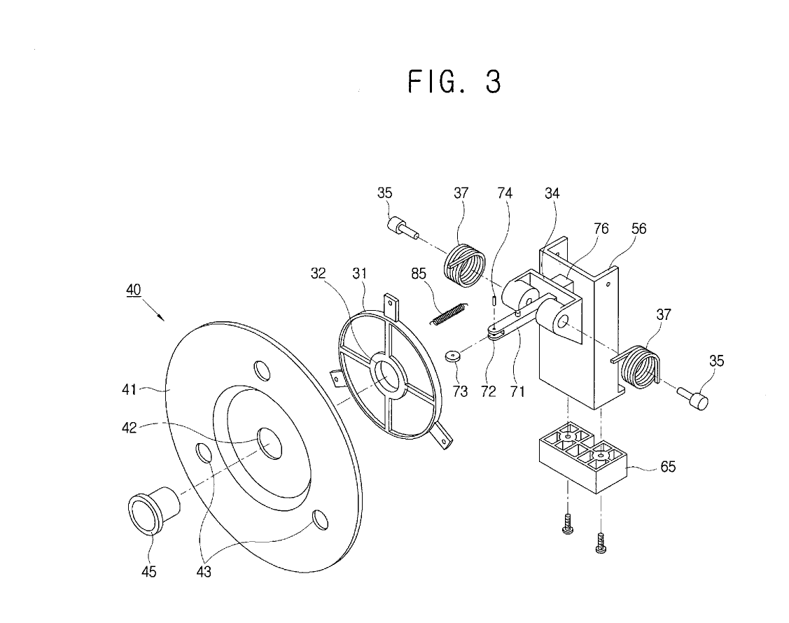

The roller 73 is rotatbly coupled with a roller supporter 72 (see, for example, FIG. 3), which is provided on a front end part of the moving member 71, by a supporting pin 74, to cause a rolling contact along a projecting surface of the pressure projection 81.

The moving member 71 may move in the backward direction toward the guide frame 51 and away from the display main body 10 as the roller 73 rolls in contact with the pressure projection 81 while the pressure projection 81 pivots together with the display main body 10.

The elastic member 85 pulls the moving member 71 toward the display main body 10 so that the moving member 71 contacts the pressure projection 81. As an exemplary embodiment of the present general inventive concept, the elastic member 85 can be shaped like a coil spring which is coupled at the one end with the moving member 71 and at the other end to the tilting bracket 31 so that the roller 73 of the moving member 71 contacts the pressure projection 81 while the display main body 10 pivots, but the shape and/or form of the elastic member 85 is not limited thereto. Alternatively, the elastic member 85 may be provided in various shapes and forms, such as a plate spring shape or a rubber material form. Alternatively, the moving member 71 may be coupled with the pivoting bracket 41 and/or with the lifting member 56 so that the elastic member 85 continuously biases the moving member 71 toward the display main body 10.

The locking projection 75 is provided on the guide frame 51 to prevent the moving member 71 from moving backward (in the direction toward the guide frame 51) when the lifting member 56 moves downward along the guide frame 51 by predetermined distances with respect to the guide frame 51. As an exemplary embodiment of the present general inventive concept, the locking projection 75 protrudes forward of the guide frame while extending along a lengthwise direction of the guide frame 51. Thus, when the display main body 10 is positioned at the upper part of the guide frame 51, the moving member 71 may move backward and into the guide frame 51 without interference from the locking projection 75 when the display main body 10 pivots. When the display main body 10 is in a pivoted position, the moving member 71, and hence the display main body 10, is prevented from moving downward along the length of the guide frame 51 by being interfered with by an upper end of the locking projection 75 (see, for example, FIGS. 2, 6 and 7). Therefore, even when the display main body 10 pivots in clockwise and counterclockwise directions, the display main body 10 may pivot so that no part of the display main body 10 contacts the base member 20 or the installing surface. An upper end of the locking projection 75 may be changed in position to adjust the limit in which the moving member 71 and display main body 10 is limited from moving downward along the guide frame 51.

As illustrated in FIGS. 5 and 6, the pressure projection 81 comprises a protruding part 82 which can have a shape like a circular arc to press the moving member 71 when the display main body 10 pivots, and an inclination part 83 which can be provided to incline from the surface of the pivoting bracket 41 to an end part of the protruding part 82 to gradually move the moving member 71 up onto the surface of the protruding part 82 as the moving member 71 rolls in contact with the inclination part 83. As an exemplary embodiment of the present general inventive concept, the pressure projection 81 can be provided on the pivoting bracket 41, but is not limited thereto. Alternatively, the pressure projection 81 may be provided on a rear surface of the display main body 10.

The protruding part 82 protrudes in a backward direction from the pivoting bracket 41 to contact the moving member 71. The protruding part 82 can be shaped like a circular arc to partly surround the pivoting shaft accommodator 42 of the pivoting bracket 41. Thus, the protruding part 82 pivots together with the display main body 10 and presses the moving member 71, which is coupled with the lifting member 56 to move forward and backward between the display main body 10 and the guide frame 51.

The inclination part 83 is provided on the end part of the protruding part 82 to gradually guide the roller 73 of the moving member 71 from the surface of the pivoting bracket 41 onto the protruding part 82. Thus, the moving member 71 becomes in contact with the protruding part 82 by the aid of the inclination part 83 to move backward when the display main body 10 pivots.

As illustrated in FIGS. 5 and 6, when the display main body 10 is positioned at the upper part of the guide frame 51, the moving member 71 becomes pressed by the pressure projection 81 to move backward while the display main body 10 pivots around the pivoting shaft 45. As the moving member 71 is prevented from moving backward by the locking projection 75 while the lifting member 56 moves downward along the guide frame 51 by predetermined distances, the pressure projection 81 is prevented from pivoting by the moving member 71, and as a result, the display main body 10 also can not pivot.

As illustrated in FIG. 2, the swivel unit 90 allows the display main body 10 to swivel around the rotating axis 98. The swivel unit 90 comprises the swivel bracket 91 which is provided on the lower part of the guide frame 51, a swivel supporter 93 which protrudes upward from the base member 20, and a swivel shaft 95 which connects the swivel bracket 91 and the swivel supporter 93 to allow the guide frame 51, and hence the display main body 10, to swivel. The swivel unit 90 may further comprise at least one washer 97 which is provided between the swivel bracket 91 and the swivel supporter 93.

As an exemplary embodiment of the present general inventive concept, the swivel shaft 95 is shaped like a bolt to be accommodated within the swivel bracket 91 and the swivel supporter 93 and to be coupled with a coupling nut 96. Thus, the swivel bracket 91 can have a predetermined rotation friction force with respect to the swivel supporter 93. A user may swivel the display main body 10 with respect to the base member 20 by overcoming such a predetermined rotation friction force.

With this configuration, a process of operating the display apparatus 1 according to the present general inventive concept will be described.

As illustrated in FIG. 9, the display main body 10 may pivot around the pivoting shaft 45 when the display main body 10 moves to the upper part of the guide frame 51 of the lifting unit 50. Then, the moving member 71 moves above the upper part of the locking projection 75 by the pressure projection 81 and is not interfered with by the locking projection 75 when the display main body 10 pivots (see FIGS. 2 and 5 through 7). Also, when the display main body 10 remains pivoted, the moving member 71 is interfered with by the upper end of the locking projection 75 and is therefore prevented from moving downward, thereby preventing the display main body 10 at an upper position along the guide frame 51, together with the moving member 71, from moving downward.

As the display main body 10 is limited from moving downward when remaining pivoted (i.e., the longer length extending upward and downward), the lower part of the display main body 10 is prevented from contacting the base member 20 or the installing surface. Also, when the display main body 10 remains in the pivoted position, the display main body 10 may move downward to the point that the lower part of the display main body 10 does not contact the base member 20 or the installing surface. This can be accomplished by adjusting the height of the locking projection member 75

As illustrated in FIG. 8, the display main body 10 can not pivot around the pivoting shaft 45 when the display main body 10 is moved downward by predetermined distances from the upper part of the guide frame 51 of the lifting unit 50. Then, the moving member 71 cannot further move backward as it is interfered with by the locking projection 75 when moving backward by a force of the pressure projection 81 while the display main body 10 is attempting to be pivoted. Accordingly, the display main body 10 cannot further pivot either (see FIGS. 5 through 7).

The display apparatus according to the present general inventive concept limits the pivoting operation of the display main body by providing the locking unit when the display main body moves downward by predetermined distances with respect to the guide frame, thereby preventing the display main body from contacting the base member or the installing surface when the display main body pivots.

The locking unit may limit the pivoting operation of the display main body by providing a moving member moving with a pivoting operation of the display main body and the locking projection limiting the movement of the moving member.

As illustrated in FIG. 1, the display main body 10 of the display apparatus 1 according to the present general inventive concept may tilt around the tilt axis 38 to face in upward and downward directions, and may swivel around the rotating axis 98 in leftward and rightward directions.

Thus, the display apparatus according to the present general inventive concept may pivot, tilt and swivel the display main body with respect to the base member, thereby providing various viewing angles to a user.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus comprising a display main body that displays an image thereon and a base member, the display apparatus further comprising:
a lifting unit which comprises a guide frame to connectably stand on the base member and a lifting member coupled with the guide frame to move with the display main body;
a pivoting unit provided between the display main body and the lifting member and to support the display main body to pivot around a pivot axis in clockwise and counterclockwise directions; and
a locking unit which comprises a moving member to be lifted together with the display main body and to move with a pivoting operation of the display main body, and a locking projection provided on the guide frame to limit the moving range of the moving member when the display main body remains pivoted.

2. The display apparatus according to claim 1 further comprising:
a moving member guide provided on the lifting member and to support the moving member to move in a backward direction away from the display main body and toward the guide frame when the display main body pivots.

3. The display apparatus according to claim 2, wherein the locking unit further comprises a pressure projection which rotates together with the display main body and presses the moving member backward when the display main body rotates.

4. The display apparatus according to claim 3, wherein the pressure projection comprises a protruding part which is shaped like a circular arc and presses the moving member when the display main body pivots, and an inclination part which is provided on an incline on an end part of the protruding part to gradually move the moving member.

5. The display apparatus according to claim 4, wherein a roller is provided on an end part of the moving member to roll in contact with the pressure projection.

6. The display apparatus according to claim 2, wherein the locking unit comprises an elastic member which biases the moving member toward the display main body.

7. The display apparatus according to claim 3, wherein the pivoting unit comprises a pivoting bracket which is coupled with the display main body, and a pivoting shaft which supports the pivoting bracket to pivot with respect to the lifting member; and wherein
the pressure projection is provided on the pivoting bracket.

8. The display apparatus according to claim 4, wherein the pivoting unit comprises a pivoting bracket which is coupled with the display main body and a pivoting shaft which supports the pivoting bracket to pivot with respect to the lifting member; and wherein
the pressure projection is provided on the pivoting bracket.

9. The display apparatus according to claim 1, wherein the lifting unit further comprises a lifting spring provided between the lifting member and the guide frame to bias the lifting member along the guide frame away from the base member.

10. The display apparatus according to claim 1, the display apparatus further comprising:
a swivel unit provided between the lifting unit and the base member and to support the display main body to swivel around a rotating axis that extends through a lengthwise direction of the guide frame.

11. The display apparatus according to claim 10, wherein the swivel unit comprises:
a swivel bracket provided on a lower part of the guide frame;
a swivel supporter which protrudes from the base member; and
a swivel shaft which connects the swivel bracket to swivel with respect to the swivel supporter.

12. The display apparatus according to claim 1, further comprising:
a tilting unit provided between the lifting unit and the pivoting unit and to support the display main body to tilt around a tilt shaft to face in upward and downward directions.

13. The display apparatus according to claim 12, wherein the tilting unit comprises:
a tilting bracket coupled with the pivoting unit;
a tilting supporter coupled with the lifting member; and
a tilting shaft which tiltably connects the tilting bracket and the tilting supporter.

14. A supporting apparatus comprising a base member to support a display main body that displays an image thereon, the supporting apparatus further comprising:
a lifting unit which comprises a guide frame to connectably stand on the base member and a lifting member coupled with the guide frame to move with the display main body;
a pivoting unit provided between the display main body and the lifting member and to support the display main body to pivot around a pivot axis in clockwise and counterclockwise directions; and
a locking unit which comprises a moving member to be lifted together with the display main body and to move with a pivoting operation of the display main body, and a locking projection provided on the guide frame to limit the moving member from moving downward along a length of the guide frame when the display main body remains pivoted.

15. The supporting apparatus according to claim 14, further comprising:
a moving member guide provided on the lifting member and to support the moving member to move in a backward direction away from the display main body and toward the guide frame when the display main body pivots.

16. The supporting apparatus according to claim 15, wherein the locking unit further comprises a pressure projection which rotates together with the display main body and presses the moving member backward when the display main body rotates.

17. The supporting apparatus according to claim 16, wherein the pressure projection comprises a protruding part shaped like a circular arc and presses the moving member when the display main body pivots, and an inclination part provided on an incline on an end part of the protruding part to gradually move the moving member.

18. The supporting apparatus according to claim 17, wherein a roller is provided on an end part of the moving member to roll in contact with the pressure projection.

19. The supporting apparatus according to claim 15, wherein the locking unit comprises an elastic member which biases the moving member toward the display main body.

20. The supporting apparatus according to claim 16, wherein the pivoting unit comprises a pivoting bracket coupled with the display main body, and a pivoting shaft which supports the pivoting bracket to pivot with respect to the lifting member; and wherein
the pressure projection is provided on the pivoting bracket.

21. The supporting apparatus according to claim 17, wherein the pivoting unit comprises a pivoting bracket coupled with the display main body and a pivoting shaft which supports the pivoting bracket to pivot with respect to the lifting member; and wherein
the pressure projection is provided on the pivoting bracket.

22. The supporting apparatus according to claim 14, wherein the lifting unit further comprises a lifting spring provided between the lifting member and the guide frame to bias the lifting member upward along the length of the guide frame.

23. The supporting apparatus according to claim 14, further comprising:
a swivel unit provided between the lifting unit and the base member and to support the display main body to swivel around a rotating axis in a lifting direction of the display main body.

24. The supporting apparatus according to claim 23, wherein the swivel unit comprises:
a swivel bracket provided on a lower part of the guide frame;
a swivel supporter which protrudes from the base member; and
a swivel shaft which connects the swivel bracket and the swivel supporter to swivel.

25. The supporting apparatus according to claim 14, further comprising:
a tilting unit provided between the lifting unit and the pivoting unit and to support the display main body to tilt around a tilting shaft to face in upward and downward directions.

26. The supporting apparatus according to claim 25, wherein the tilting unit comprises:
a tilting bracket coupled with the pivoting unit;
a tilting supporter coupled with the lifting member; and
a tilting shaft which tiltably connects the tilting bracket and the tilting supporter.
